(19) United States
(12) Patent Application Publication
(10) Pub. No.: US 2002/0156945 A1
(43) Pub. Date: Oct. 24, 2002

(54) Computer system, resource allocating method thereof and resource allocating program thereof

(75) Inventor: Tatsuya Takada, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/109,246

(22) Filed: Mar. 28, 2002

(30) Foreign Application Priority Data
Mar. 28, 2001 (JP) 2001-093511

(51) Int. Cl. G06F 3/00

(52) U.S. Cl. 710/8

(57) ABSTRACT

In ROM is stored a firmware having steps of: obtaining from PCI devices which are mounted at the present moment, information regarding to size of resources to be required; obtaining by input of user, information regarding to size of resources to be required by PCI devices which will be mounted on in the future; and allocating resources for PCI devices with adding up above mentioned both capacities of resources. In main storage unit is stored a software having a step when PCI device is newly added on while the system is under its operation, to allocate resources allocated for peripheral devices which will be mounted on in the future to PCI device newly added on. CPU executes the firmware at Start up process and executes the software when peripheral device is added on while system is under its operation.

### BACKGROUND OF THE INVENTION

1. Technical Field of the Invention

The present invention relates to a computer system, a resource allocating method thereof and a resource allocating program thereof in which a resource management for computer system is improved, especially relates to an improvement in a resource allocation method of PCI slot for computer system.

2. Description of the Related Art

A peripheral computer interconnect (hereinafter refereed to as “PCI”) device which is mounted on a slot of the PCI bus requires main storage space or IO space as a resource to operate. And the resource size required by each PCI device is different with respect to each device.

A computer system allocates resources of main storage space or IO space to the respective PCI devices according to a firmware to start up the system (hereinafter refereed to as “BIOS”).

In a general method to allocate the resource of computer system in the prior art technology, the system allocates the resource to each PCI bus bridge as a uniform fixed amount when the system is started up, according to the BIOS. And when a new PCI device is installed in addition to a vacant slot while the system is under its operation, the fixed amount of resource which is set up when the system is started up, is allocated to the PCI device.

By means of the resource allocating method in prior art, a PCI device which requires much more amount of size of resource than that amount which is set up at the time of system starting up, cannot be installed even when it is added on a vacant slot while the system is under its operation.

In such case there is a necessity that a user of the computer system halts its operation of the computer once and re-start it. When the computer system has been restarted, the resources which are required by all the PCI devices including the added on PCI device, are calculated again and the amount of resources to be allocated to respective PCI bus bridges is decided in compliance with the BIOS.

In accordance with this fact, for example, when a PCI device is added on to get it's capability expanded on a computer system which is utilized by the user for his business, he must interrupt his process once and halt the operation of the system, and it is not preferable when it is viewed in terms of an operationality and a maintainability.

### SUMMARY OF THE INVENTION

It is an object of the present invention to provide a computer system, the resource allocating method thereof and the resource allocating program thereof in and by which any PCI device can be added on the computer system even while the system is under its operation.

A computer system according to one aspect of the present invention is the computer system to operate with allocation of resources to peripheral devices. The computer system includes: a memory in which is stored a firmware having steps of; obtaining from said peripheral devices which are mounted at the present moment, an information regarding to size of the resources to be required for operations of said devices; obtaining by manual input of a user, an information regarding to size of the resources to be required for operations of peripheral devices which will be mounted on in the future; and allocating resources for peripheral devices including said size of the resources to be required for operation of said peripheral devices which are mounted on at the present moment and said size of the resources to be required for operations of said peripheral devices which will be mounted on in the future; a storage unit in which is stored a software having a step when a peripheral device is newly added on while the system is under its operation, to allocate said resources allocated for said peripheral devices which will be mounted on in the future, to said peripheral device newly added on; and a CPU to fetch and execute said firmware from said memory when the system is started up, and to execute said software when a peripheral device is newly added on while the system is under its operation.

In accordance with the present invention because a user can set up at a Start up process, an allocation of resource to respective peripheral devices including peripheral devices which will be added on the system in the future, re-stating of the system to re-allocate the resource is not necessary even when a peripheral device is newly added on while the system is under its operation.

A computer system according to another aspect of the present invention is the computer system to operate with allocation of resources to peripheral devices which are connected to a plurality of bridges including: a memory, a storage unit and a CPU. Said memory stores a firmware having steps of; obtaining from said peripheral devices which are mounted at the present moment, an information regarding to size of the resources to be required for operations of the devices; obtaining respectively for said bridges by manual input of a user, an information regarding to size of the resources to be required for operations of the peripheral devices which will be mounted on in the future; and allocating respectively for said bridges resources for peripheral devices including said size of the resources to be required for operation of said peripheral devices which are mounted on at the present moment and said size of the resources to be required for operations of the peripheral devices which will be mounted on in the future. Said storage unit stores a software having a step when a peripheral device is newly added on while the system is under its operation, to allocate said resources allocated for said peripheral devices which will be mounted on in the future to said peripheral device newly added on. Said CPU fetches and executes said firmware from said memory when the system is started up, and executes said software when a peripheral device is newly added on while the system is under its operation.

A resource allocating method according to one aspect of the present invention is a resource allocating method to allocate resources of computer system to peripheral devices including the steps of: obtaining from said peripheral devices which are mounted on said computer system at the present moment, an information regarding to size of the resources to be required for operations of said devices; obtaining by manual input of a user, an information regarding to size of the resources to be required for operations of peripheral devices which will be mounted on said computer system in the future; and allocating resources for peripheral devices including said size of the resources to be required for operation of said peripheral devices which are mounted on at the present moment and said size of the resources to be required for operations of the peripheral devices which will be mounted on in the future.

A resource allocating method according to another aspect of the present invention is a resource allocating method to allocate resources of computer system to peripheral devices which are connected to a plurality of bridges including the steps of: obtaining from said peripheral devices which are mounted on said computer system at the present moment, an information regarding to size of the resources to be required for operations of said devices; obtaining respectively for said bridges by manual input of a user, an information regarding to size of the resources to be required for operations of the peripheral devices which will be mounted on said computer system in the future; and allocating resources respectively for said bridges for peripheral devices including said size of the resources to be required for operation of said peripheral devices which are mounted on at the present moment and said size of the resources to be required for operations of peripheral devices which will be mounted on in the future.

A resource allocating program according to the present invention is a resource allocating program to allocate resources of computer system to peripheral devices including: a process to obtain from said peripheral devices which are mounted at the present moment, an information regarding to size of the resources to be required for operations of said devices; a process to obtain by manual input of a user, an information regarding to size of the resources to be required for operations of peripheral devices which will be mounted on in the future; and a process to allocate resources for peripheral devices including said size of the resources to be required for operation of said peripheral devices which are mounted on at the present moment and said size of the resources to be required for operations of the peripheral devices which will be mounted on in the future.

Another resource allocating program according to another aspect of the present invention is a resource allocating program to allocate resources of computer system to peripheral devices which are connected to a plurality of bridges including: a process to obtain from said peripheral devices which are mounted at the present moment, an information regarding to size of the resources to be required for operations of said devices; a process to obtain respectively for said bridges by manual input of a user, an information regarding to size of the resources to be required for operations of peripheral devices which will be mounted on in the future; and a process to allocate resources respectively for said bridges for peripheral devices including said size of the resources to be required for operation of said peripheral devices which are mounted on at the present moment and said size of the resources to be required for operations of the peripheral devices which will be mounted on in the future.

### BRIEF DESCRIPTION OF THE DRAWINGS

FIG. 1 is a block diagram to illustrate a configuration of the computer system according to one embodiment of the present invention.

FIG. 2 is a diagram to illustrate an inner register configuration of a control register included in the embodiment of the present invention.

FIG. 3 is a diagram to illustrate one example of a Set up screen displayed on an operating terminal station for setting of resources by user.

FIG. 4 is a flow chart to illustrate an operation of the computer system according to the embodiment of the present invention.

FIG. 5 is a diagram to illustrate one example of main storage area set up on a PCI bus bridge in compliance with a system Start up process of the computer system of the embodiment of the present invention.

FIG. 6 is a block diagram to illustrate one configuration of a computer system of another embodiment of the present invention which has two PCI bus bridges.

FIG. 7 is a diagram to illustrate one example of main storage area set up on two PCI bus bridges in compliance with a system Start up process in the computer system illustrated in FIG. 6.

FIG. 8 is a diagram to illustrate one example of Set up screen in the computer system illustrated in FIG. 6.

### DETAILED DESCRIPTION OF THE PREFERRED EMBODIMENTS

Hereinafter preferred embodiments according to the present invention will be described in detail with reference to attached drawings.

FIG. 1 is a block diagram to illustrate a configuration of the computer system according to one embodiment of the present invention.

The computer system 10 includes a CPU 11, a main storage device 12, a PCI bus bridge 13, a ROM 14, PCI devices 151, 152, . . . , 15n and an operating terminal 16.

The CPU 11, main storage device 12 and PCI bus bridge 13 are connected together with CPU bus 17. The PCI bus bridge 13 and ROM 14 are connected together. Further, the PCI bus bridge 13 and PCI devices 151, 152, . . . , 15n are connected together with PCI bus 18. Herein the operating terminal 16 is supposed to be connected to the PCI device 151. Also the PCI bus 18 is supposed to have a vacant slot 19.

The CPU 11 executes BIOS 111 when the system is started up. The BIOS 111 is a firmware to start up the system and includes a setting process to allocate the resources for respective PCI devices 151, 152, . . . , 15n which are connected to the PCI bus 18 and a reserved resource for the vacant slot 19. In this embodiment allocation of resources for the respective PCI devices 151, 152, . . . , 15n is executed automatically in compliance with the computer system 10, and allocation of the reserved resource is executed in compliance with a user setting. The set up values of amount of allocated resource are stored in the PCI bus bridge 13.

In addition, a value of the automatically allocated amount for the respective PCI devices 151, 152, . . . , 15n may also be altered in compliance with the user.

The main storage device 12 stores information with regard to the system such as a series of the CPU commands, calculation data and so on.

The PCI bus bridge 13 controls a transferring of transaction between the CPU bus 17 and the PCI bus 18 in accordance with the allocation of resource to the respective PCI devices 151, 152, . . . , 15n. The PCI bus bridge 13 has a control register 131.

The control register 131 includes registers to designate regions of the main storage space and the IO space that should be controlled by the PCI bus bridge.

The ROM 14 is a kind of non volatile memory such as flash ROM and so on. In the ROM 14 there are a storage area 141 for BIOS codes and a storage area 142 for SG information. The SG information is an abbreviation for System Generation information and it means information with regard to the system configuration which are set up to utilize in a Start up process. The SG information include those on size of resource and so on that is set up at a setting process for resources to be allocated to the PCI devices (hereinafter refereed to as “Set up process”). The Set up process is included in the processes in compliance with the BIOS 111.

The PCI devices 151, 152, . . . , 15n are peripheral devices which are connected to the PCI bus 18 and afford various functions.

The operating terminal 16 displays screens while the BIOS 111 is operating (during the Start up process) including the Set up process, and transfers user's operation corresponding to content of the screen to the CPU 11. Also the operating terminal 16 displays screens of the operating system and transfers user's operation corresponding to content of the screen to the CPU 11.

The CPU bus 17 is a local bus which belongs to the CPU 11.

The PCI bus 18 is a multi purpose bus according to the standard specification for bus stipulated as the PCI local bus standard specification.

The vacant slot 19 is one of slot for the PCI bus 18 (PCI slot) to which no PCI device is connected. To the vacant slot 19 it is possible to allocate the reserved resource that is set up in the Set up process by a user. By this arrangement it is possible to add on more PCI device at the vacant slot 19 and to mount into the computer system 10 while the system is under its operation (so called “hot plug”).

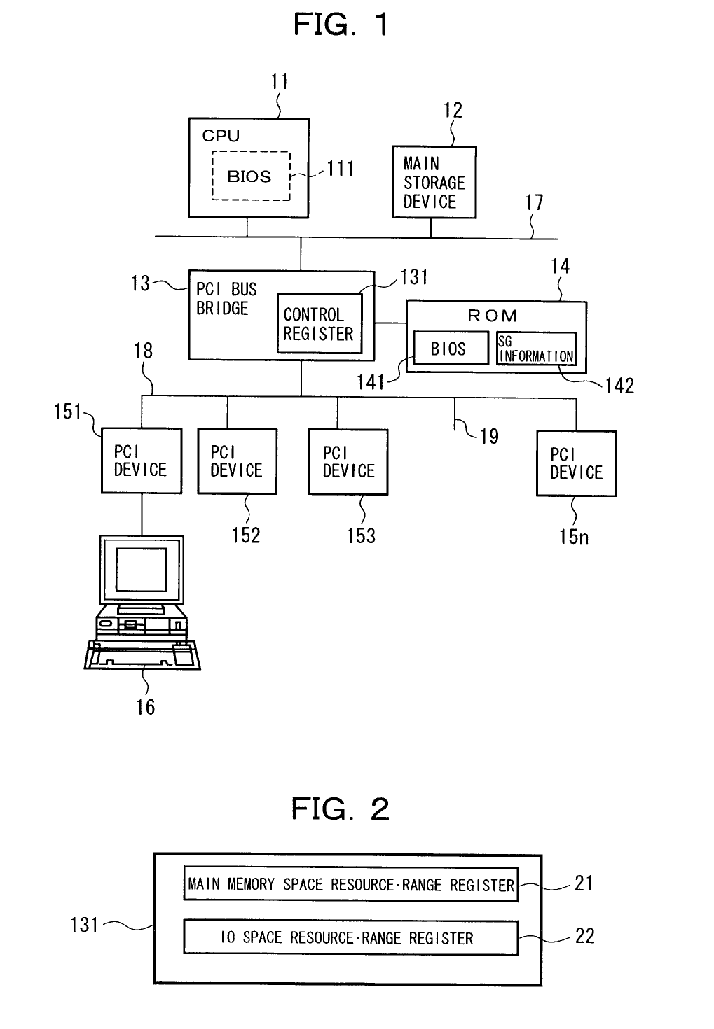

FIG. 2 is a diagram to illustrate an inner register configuration of a control register 131 included in one embodiment of the present invention.

The control register 131 includes a main memory space resource range register 21 and an IO space resource range register 22. The main memory space range register 21 designates a range of main memory space (main memory space resource range) to be controlled by the PCI bus bridge 13 with its start address and end address. The IO space resource range register 22 designates a range of IO space (IO space resource range) to be controlled by the PCI bus bridge 13.

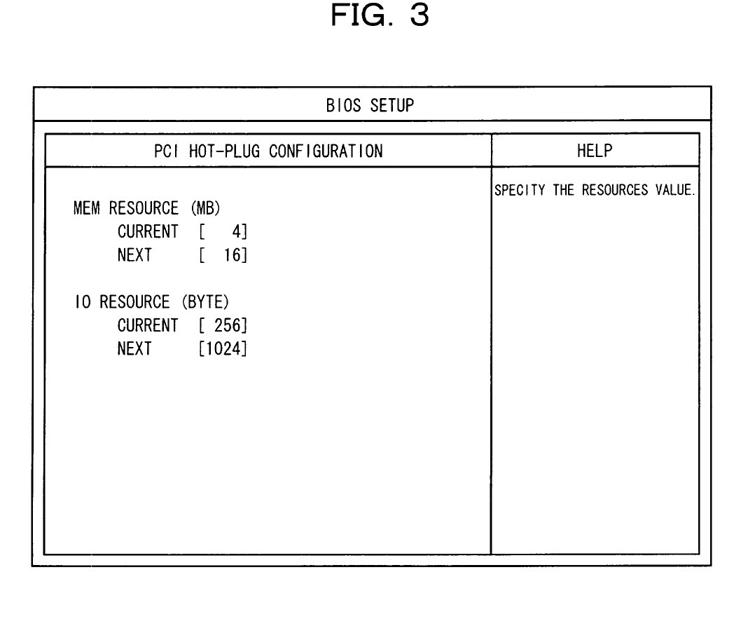

FIG. 3 is a diagram to illustrate one example of screen (Set up screen) displayed on the operating terminal 16 for setting of reserved resources by user (i.e. resource for hot plug) at Set up process. A value that the system holds present (Current value) and value when the system will hold at next start (Next value) of the resource for main memory space (Mem Resource) and the resource for IO space (IO Resource) at hot plug process are displayed. The user beforehand researches a required resource for PCI device which has a possibility to be utilized in the future, and set up the reserved resource to be allocated to the vacant slot 19 at this screen. The computer system 10 sets up on the PCI bus bridge 13 resources to be allocated to the respective PCI devices 151, 152, . . . , 15n, and reserved resource which is capable of being allocated to the vacant slot 19 on the basis of the Set up value when the system is started up in compliance with the BIOS.

As above described the present invention has a characterizing feature that a user can set up resource for hot plug process and the Set up value is set on the PCI bus bridge 13.

Incidentally, in the above described embodiment the screen shown in FIG. 3 is used as one example of screen, however the present invention is not limited to a screen of the kind, and the configuration of a screen is not object in the present invention where a user can set up the resource on it.

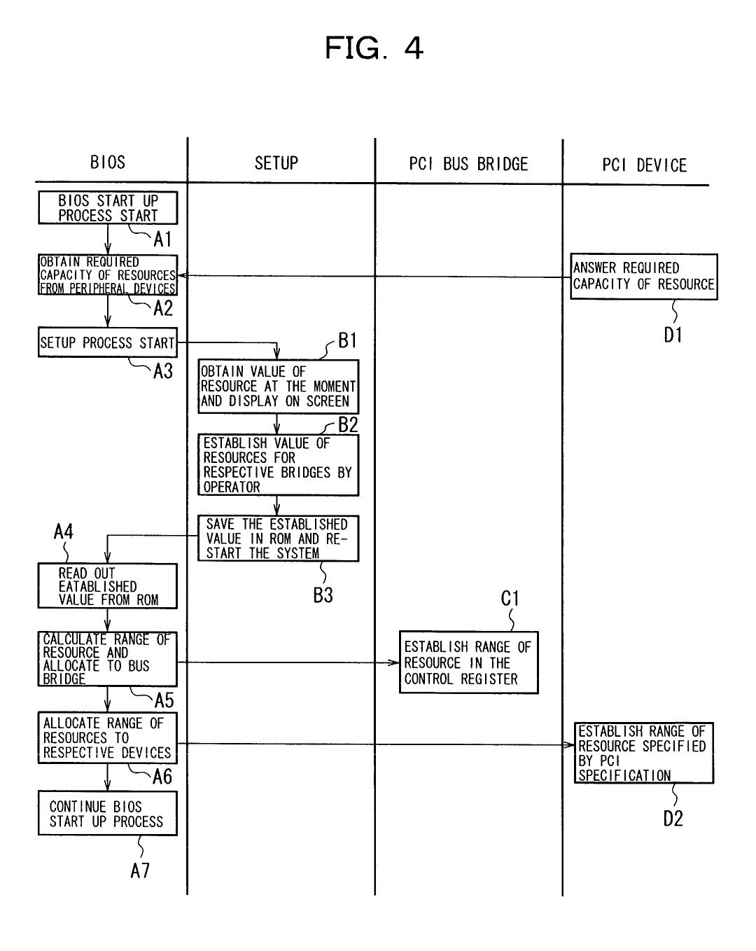

FIG. 4 is a flow chart to illustrate an operation of the computer system 10 according to an embodiment of the present invention. In FIG. 4 the Set up process is separated and individually illustrated from the Start up process of BIOS for the system.

Firstly, when a power switch of the computer system 10 is turned on, the CPU 11 starts to fetch BIOS codes from the BIOS stored area 141 in the ROM 14 at step A1. When the CPU 11 executes a content of the fetched BIOS codes, the Start up process of BIOS 111 for the system is achieved.

The CPU 11 obtains information regarding to the size of resource that are required by the respective PCI devices 151, 152, . . . , 15n mounted on the computer system 10 from respective devices by the BIOS 111 at step A2 during a Start up process of BIOS 111 for the system. The method by which the CPU 11 obtains the information regarding to the resources from the respective PCI devices 151, 152, . . . , 15n, is based on a method specified by the standard specification for bus stipulated as the PCI local bus standard specification. By this operation the respective PCI devices 151, 152, . . . ,15n give notice the resource information which are required by themselves to the CPU 11 at step D1.

After all the resource information about all the respective PCI devices 151, 152, . . . , 15n have been obtained, the CPU 11 boots up the Set up process in compliance with a system Start up process in the BIOS 111.

When the Set up process is booted up, a Set up screen such as illustrated in FIG. 3 is displayed on the operating terminal 16 at step B1, and manipulation by a user on the operating terminal 16 becomes possible. The capacities of rescues to be allocated to the PCI bus bridge 13 which are automatically calculated on the basis of resource information of the PCI devices obtained at the step A2, are displayed on the Set up screen. In this embodiment a value of size of the resource which is applied at the marching process at the present moment and a value of size of the resource which will be applied at the process being started next are displayed on the screen.

The user sets up an amount of resource to be stored in the PCI bus bridge 13 at step B2 with reference to the screen illustrated in FIG. 3 and in consideration of the resource information of PCI device which has a possibility to be added on the system in the future. Incidentally the user beforehand researches and comprehends an amount of resource required by a PCI device that has a possibility to be added on during the operation though it has not yet been mounted on the PCI slot at this moment.

After a setting by the user has been completed, the CPU 11 record the Set up value in the storage area 142 for SG information and reboot the computer system 10 by the Set up process at step B3.

During the reboot process the CPU 11 refers to the ROM 14 for the SG information in compliance with the BIOS 111. Then the CPU 11 sets up the resource at the PCI bus bridge 13 at step A5 and sets up the resource in the respective PCI resources 151, 152, . . . , 15n at step A6.

The range of resources are set up on the control register 131 of PCI bus bridge 13 at step C1. And the range of resources are set up on the PCI devices 151, 152, . . . ,15n at step D2.

At the same time the CPU 11 continues to execute other processes of the system start up in compliance with the BIOS 111 at step A7.

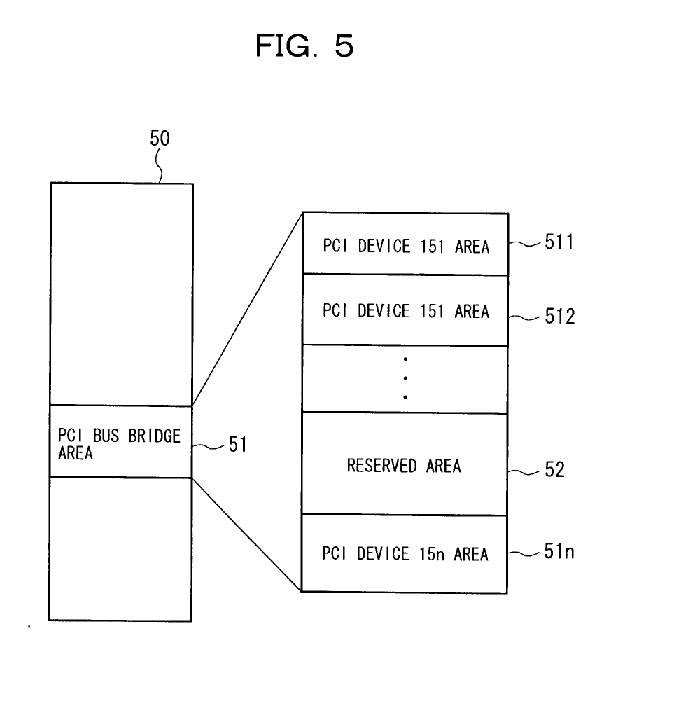

FIG. 5 is a diagram to illustrate one example of main storage area set up on the PCI bus bridge 13 in compliance with a system Start up process of the computer system 10 of one embodiment of the present invention. Herein an example of case where a part of the main storage space is allocated as a resource to the PCI bus bridge 13, is illustrated in FIG. 5. In addition to the main storage space, the IO space can be allocated as a resource in the standard specification for bus stipulated as the PCI local bus standard specification.

When referring to FIG. 5, a predetermined area in a main storage space 50 is an allocated area 51 (PCI bus bridge area) to the PCI bus bridge 13. There are allocated areas (PCI device areas) 511, 512, . . . , 51n which are allocated to the respective PCI devices and a reserved area 52 which is set up at the Set up process and is capable of being allocated to the vacant slot 19 in the PCI bus bridge area 51 as well.

At first the CPU 11 defines the PCI bus bridge area 51 in the main storage space 50 in compliance with the BIOS 111. A range of the defined PCI bus bridge area 51 is set in the control register 131. By this setting the PCI bus bridge 13 becomes capable of response to the access by the CPU 11 or the PCI devices 151, 152, . . . , 15n to the PCI bus bridge area 51.

Next the CPU 11 allocates the resources which are required by the respective PCI devices 151, 152, . . . , 15n in the PCI bus bridge area 51 and defines as the PCI device areas 511, 512, . . . , 51n. At the same time the CPU 11 defines the reserved area 52 in the PCI bus bridge area 51.

At this point in FIG. 5 an example of allocation of resources to the main storage space 50 is illustrated, however, the allocation of resources to the IO space can be achieved in similar way.

When a new PCI device is added on and connected to the vacant slot 19 (hot plug in) while the system is under its operation, by operating system of the system according to the present invention, the added on PCI device is allocated to the reserved area 52 which is set up by the CPU 11 in compliance with the BIOS 111 at the system Start up process. By this allocation the PCI device which is added on, becomes capable of operating by means of the reserved area 52 (a built in state).

Herein an example of allocation is merely described for the main storage space 50 to a new added on PCI device, however, the allocation of reserved area in the IO space can be achieved in similar way by the operating system.

In accordance with this embodiment, because the user can allocate the resources to respective PCI bus bridges by means of Set up process of the BIOS 111 in consideration with the configuration of mounting of PCI devices at the present and the future which have been confirmed beforehand by a user, there happens no shortage of the resource even when a peripheral device is newly added on as hot plug in while the system is under its operation, and thus restating of the system to build the PCI device in the computer system is not necessary.

In FIG. 1 a computer system 10 which has only one PCI bus bridge is illustrated as an example, however, the computer system according to the present invention may also have a plurality of PCI bus bridges.

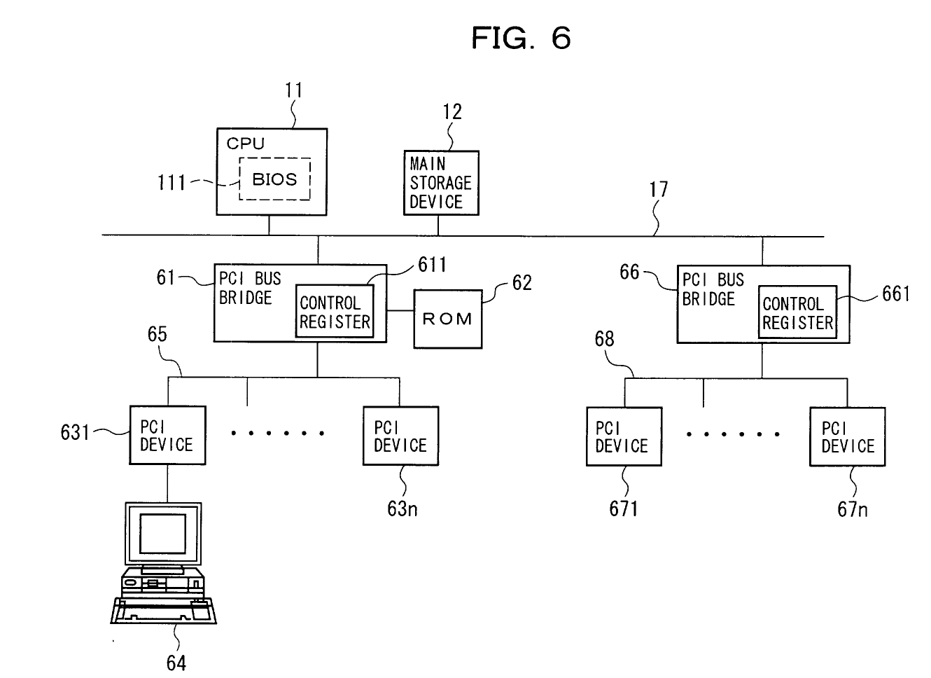

FIG. 6 is a block diagram to illustrate a configuration of a computer system of another embodiment of the present invention which has two PCI bus bridges.

A computer system 60 includes the CPU 11, the main storage device 12, PCI bus bridge 61, 66, a ROM 62, PCI devices 631, 632, . . . , 63n, 671, 672, . . . ,67n and an operating terminal 64.

The CPU 11, main storage device 12 and PCI bus bridge 61, 66 are connected together with the CPU bus 17. The CPI bus bridge 61 and ROM 62 are connected together. The PCI bus bridge 61 and PCI devices 631, 632, . . . , 63n are connected together with PCI bus 65. Further the PCI bus bridge 66 and PCI devices 671, 672, . . . , 67n are connected together with PCI bus 68. Herein the operating terminal 64 is supposed to be connected to the PCI device 631. Also the PCI bus 65, 68 are supposed to have vacant slots.

The PCI bus bridge 61 controls a transferring of transaction between the PCI bus 65 and the CPU bus 17 as the PCI bus bridge 13 illustrated in FIG. 1. The PCI bus bridge 66 controls a transferring of transaction between the PCI bus 65 and the CPU bus 17.

The ROM 62 is a non volatile memory of the same kind as the ROM 14 illustrated in FIG. 1, and stores the BIOS codes and SG information. But in the embodiment illustrated in FIG. 6 the SG information includes resource information for two PCI bus bridges 61, 66.

The PCI devices 631, 632, . . . , 63n, 671, 672, 67n are the peripheral devices which support various functions the same as those illustrated in FIG. 1.

The operating terminal 64 is of the same kind as the operating terminal 16 illustrated in FIG. 1.

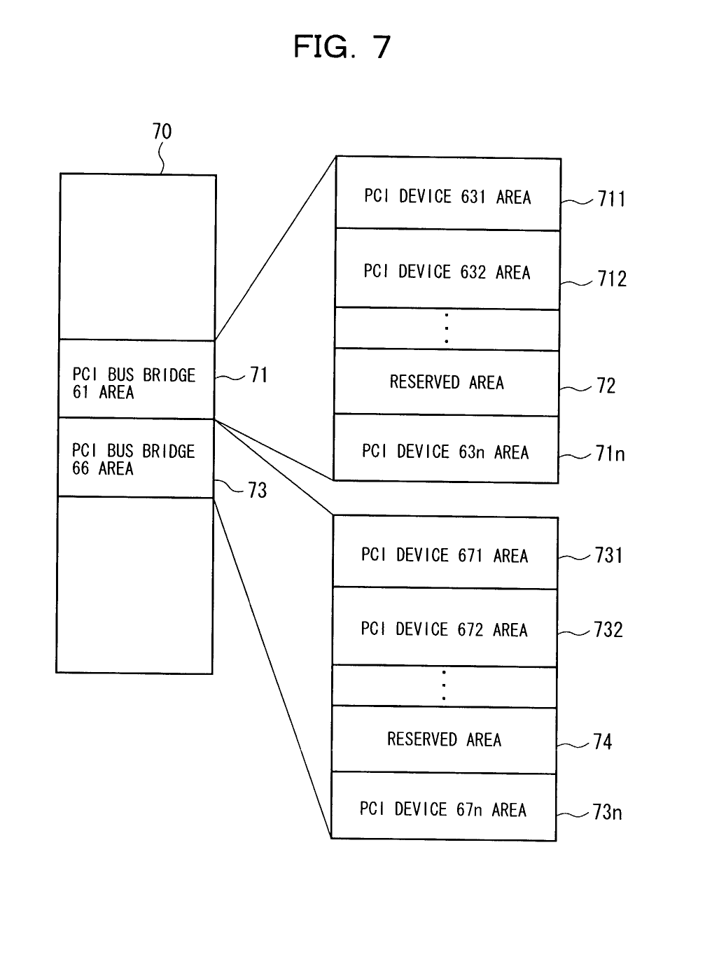

Referring to FIG. 7 a predetermined area of the main storage space is allocated to the two PCI bus bridges 61, 66 respectively. And these two areas are allocated so as not to be overlapped.

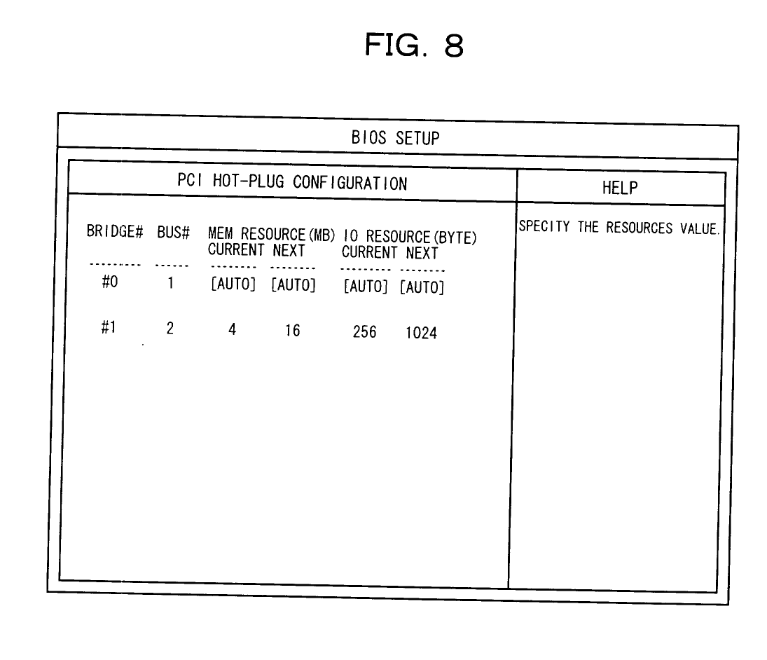

FIG. 8 is a diagram to illustrate one example of Set up screen in the computer system 60 illustrated in FIG. 6. In the Set up screen illustrated in FIG. 7 the resources are displayed which are respectively allocated for two PCI bus bridges (Bridge #0, #1). Incidentally when the setting of reserved area by a user is not necessary, the allocation of resources may be achieved automatically, and in FIG. 8 an example is illustrated that one of the PCI bus bridge (Bridge #0) is automatically allocated (Auto Allocation mode).

An operation of the computer system 60 in accordance with this embodiment is quite the same as that of the flowchart illustrated in FIG. 4.

According to the present invention because a user can set up at the Start up process the allocation of resource to the peripheral devices including the peripheral devices which has a possibility to be added on the system in the future, the restart up process to re-allocate the resources is not necessary and there is no need temporally to halt the operation of system even when a peripheral device is newly added on while the system is under its operation, then, operability and maintainability are improved.

What is claimed is:

1. A computer system to operate with allocation of resources to peripheral devices comprising:
a memory in which is stored a firmware having steps of;
obtaining from said peripheral devices which are mounted at the present moment, an information regarding to size of the resources to be required for operations of said devices;
obtaining by manual input of a user, an information regarding to size of the resources to be required for operations of peripheral devices which will be mounted on in the future; and
allocating resources for peripheral devices including said size of the resources to be required for operation of said peripheral devices which are mounted on at the present moment and said size of the resources to be required for operations of said peripheral devices which will be mounted on in the future;
a storage unit in which is stored a software having a step when a peripheral device is newly added on while the system is under its operation, to allocate said resources allocated for said peripheral devices which will be mounted on in the future, to said peripheral device newly added on; and
a CPU to fetch and execute said firmware from said memory when the system is started up, and to execute said software when a peripheral device is newly added on while the system is under its operation.

2. A computer system to operate with allocation of resources to peripheral devices which are connected to a plurality of bridges comprising:
a memory in which is stored a firmware having steps of;
obtaining from said peripheral devices which are mounted at the present moment, an information regarding to size of the resources to be required for operations of said devices;
obtaining respectively for said bridges by manual input of a user, an information regarding to size of the resources to be required for operations of peripheral devices which will be mounted on in the future; and
allocating respectively for said bridges resources for peripheral devices including said size of the resources to be required for operation of said peripheral devices which are mounted on at the present moment and said size of the resources to be required for operations of the peripheral devices which will be mounted on in the future;
a storage unit in which is stored a software having a step when a peripheral device is newly added on while the system is under its operation, to allocate said resources allocated for said peripheral devices which will be mounted on in the future to said peripheral device newly added on; and
a CPU to fetch and execute said firmware from said memory when the system is started up, and to execute said software when a peripheral device is newly added on while the system is under its operation.

3. A resource allocating method to allocate resources of computer system to peripheral devices comprising the steps of:
obtaining from said peripheral devices which are mounted on said computer system at the present moment, an information regarding to size of the resources to be required for operations of said devices;
obtaining by manual input of a user, an information regarding to size of the resources to be required for operations of peripheral devices which will be mounted on said computer system in the future; and
allocating resources for peripheral devices including said size of the resources to be required for operation of said peripheral devices which are mounted on at the present moment and said size of the resources to be required for operations of the peripheral devices which will be mounted on in the future.

4. A resource allocating method to allocate resources of computer system to peripheral devices which are connected to a plurality of bridges comprising the steps of:
obtaining from said peripheral devices which are mounted on said computer system at the present moment, an information regarding to size of the resources to be required for operations of said devices;
obtaining respectively for said bridges by manual input of a user, an information regarding to size of the resources to be required for operations of the peripheral devices which will be mounted on said computer system in the future; and
allocating respectively for said bridges resources for peripheral devices including said size of the resources to be required for operation of said peripheral devices which are mounted on at the present moment and said size of the resources to be required for operations of peripheral devices which will be mounted on in the future.

5. A resource allocating program to allocate resources of computer system to peripheral devices comprising:
a process to obtain from said peripheral devices which are mounted at the present moment, an information regarding to size of the resources to be required for operations of said devices;
a process to obtain by manual input of a user, an information regarding to size of the resources to be required for operations of peripheral devices which will be mounted on in the future; and
a process to allocate resources for peripheral devices including said size of the resources to be required for operation of said peripheral devices which are mounted on at the present moment and said size of the resources to be required for operations of the peripheral devices which will be mounted on in the future.

6. A resource allocating program to allocate resources of computer system to peripheral devices which are connected to a plurality of bridges comprising:
a process to obtain from said peripheral devices which are mounted at the present moment, an information regarding to size of the resources to be required for operations of said devices;
a process to obtain respectively for said bridges by manual input of a user, an information regarding to size of the resources to be required for operations of peripheral devices which will be mounted on in the future; and
a process to allocate resources respectively for said bridges for peripheral devices including said size of the resources to be required for operation of said peripheral devices which are mounted on at the present moment and said size of the resources to be required for operations of the peripheral devices which will be mounted on in the future.
